(19) United States
(12) Patent Application Publication
(10) Pub. No.: US 2016/0349585 A1
(43) Pub. Date: Dec. 1, 2016

(54) THIN FILM TRANSISTOR ARRAY SUBSTRATE AND LIQUID CRYSTAL DISPLAY PANEL

(71) Applicant: SHENZHEN CHINA STAR OPTOELECTRONICS TECHNOLOGY CO., LTD., Shenzhen, Guangdong (CN)

(72) Inventor: Zhiguang YI, Shenzhen, Guangdong (CN)

(73) Assignee: Shenzhen China Star Optoelectronics Technology Co., Ltd., Shenzhen, Guangdong (CN)

(21) Appl. No.: 14/425,044

(22) PCT Filed: Jan. 15, 2015
(86) PCT No.: PCT/CN2015/070751

§ 371 Date: Mar. 1, 2015

(30) Foreign Application Priority Data
Dec. 31, 2014 (CN) 201410853092.8

(51) Int. Cl. G02F 1/1362; G02F 1/1343; G02F 1/1333; G02F 1/1368; G02F 1/1335

(52) U.S. Cl. CPC G02F 1/136259; G02F 1/1368; G02F 1/133514; G02F 1/136286; G02F 1/133345; G02F 1/13439; G02F 1/134309; G02F 2201/121; G02F 2201/123; G02F 2001/136263; G02F 2001/13629; G02F 2001/136295

(57) ABSTRACT

A thin film transistor array substrate comprises gate lines, data lines comprising a break region, pixel regions defined by the gate lines crossing with the scan lines, and two wiring layers electrically connected with the data lines. Each of the pixel regions comprises a common electrode and a pixel electrode on the common electrode. The common electrode electrically insulates from the pixel electrode. The two wiring layers are respectively disposed at the two sides of the break region. A portion of the pixel electrode adjacent to the break region is removed. A portion of the common electrode adjacent to the break region electrically insulates from the remaining portion. The two wiring layers are electrically connected to the portion of the common electrode adjacent to the break region. The area of the pixel electrode removed by the repair approach of the break region of the disclosure is very small.

### BACKGROUND

1. Technical Field

The disclosure is related to liquid crystal display technology field, and more particular to a thin film transistor array substrate and a liquid crystal display panel.

2. Related Art

With the development of information society, the demand for flat panel displays has been growing rapidly. Liquid Crystal Display devices (abbreviated LCD) with small size, low power consumption, no radiation and other characteristics occupy a dominant position in the current flat panel display market. The LCD device usually comprises a liquid crystal display panel and a backlight module arranged oppositely. Because the liquid crystal display panel cannot emit light itself, it is necessary to use the light source provided from the backlight module to display images.

The liquid crystal display panel comprises an upper substrate, a lower substrate arranged oppositely and a liquid crystal layer disposed between the upper substrate and the lower substrate. The upper substrate is usually referred as a color filter substrate and the lower substrate is usually referred as an array substrate. In the array substrate, a thin film transistor is usually adopted for driving to display screen information with high-speed, high-brightness, and high-contrast.

However, during the current manufacture process for the array substrate, there will be a large number of signal lines disconnected. Therefore, it needs to repair the broken signal lines. The current repair method adopts long conductive lines across the common electrodes on the array substrate to repair the disconnected signal lines. However, the method results in covering of the long conductive lines on the transparent pixel electrode layer (i.e., ITO thin film layer). In order to avoid the conduction between the long conductive lines and the transparent pixel electrode layer, it is necessary to remove a portion of the transparent pixel electrode layer on the area which the long conductive lines are disposed. However, as the long conductive line occupies layer area, it requires removing a larger area of the transparent pixel electrode layer. At the corresponding location that the transparent pixel electrode layer is removed, only the common electrode on the color filter substrate drives the liquid crystal molecules in the liquid crystal layer to rotate. This makes the liquid crystal molecules at corresponding location remain deflection and makes the corresponding location be at a bight status so that a micro light point appears at the corresponding location in the LCD panel.

### SUMMARY

In order to solve the problem existing in the current technology, one embodiment of the disclosure provides a thin film transistor array substrate comprising gate lines, data lines comprising a break region, pixel regions defined by the gate lines crossing with the scan lines, each of the pixel regions comprising a common electrode and a pixel electrode on the common electrode, the common electrode electrically insulated from the pixel electrode; and two wiring layers respectively disposed at the two sides of the break region, the two wiring layers electrically connected with the data lines; wherein a portion of the pixel electrode adjacent to the break region is removed; a portion of the common electrode adjacent to the break region is electrically insulated from the remaining portion; the two wiring layers are electrically connected to the portion of the common electrode adjacent to the break region.

In one embodiment of the thin film transistor array substrate, a second insulating layer is disposed in the pixel region; the second insulating layer is disposed between the pixel electrode and the common electrode.

In one embodiment of the thin film transistor array substrate, the second insulating layer on the removed portion of the pixel electrode comprises at least two contacting hole formed therein; wherein the two wiring layers are disposed on the second insulating layer, the two wiring layers are respectively filled in the corresponding contact holes to electrically connect to the portion of the common electrode adjacent to the break region.

In one embodiment of the thin film transistor array substrate, the wiring layer is electrically insulated from the pixel electrode.

In one embodiment of the thin film transistor array substrate, the material of the common electrode and the pixel electrode is indium tin oxide; the material of the wiring layer is metal.

The other object of the disclosure is to provide a liquid crystal display panel, comprising: a thin film transistor array substrate and a color filter substrate arranged oppositely to the thin film transistor array substrate; wherein the thin film transistor array substrate comprises: gate lines; data lines comprising a break region; pixel regions defined by the gate lines crossing with the scan lines, each of the pixel regions comprising a common electrode and a pixel electrode on the common electrode, the common electrode electrically insulated from the pixel electrode; and two wiring layers respectively disposed at the two sides of the break region, the two wiring layers electrically connected with the data lines; wherein a portion of the pixel electrode adjacent to the break region is removed; a portion of the common electrode adjacent to the break region is electrically insulated from the remaining portion; the two wiring layers are electrically connected to the portion of the common electrode adjacent to the break region.

In one embodiment of the liquid crystal display panel, a second insulating layer is disposed in the pixel region; the second insulating layer is disposed between the pixel electrode and the common electrode.

In one embodiment of the liquid crystal display panel, the second insulating layer on the removed portion of the pixel electrode comprises at least two contacting hole formed therein; wherein the two wiring layers are disposed on the second insulating layer, the two wiring layers are respectively filled in the corresponding contact holes to electrically connect to the portion of the common electrode adjacent to the break region.

In one embodiment of the liquid crystal display panel, the wiring layer is electrically insulated from the pixel electrode.

In one embodiment of the liquid crystal display panel, the material of the common electrode and the pixel electrode is indium tin oxide; the material of the wiring layer is metal.

In one embodiment of the liquid crystal display panel, the material of the common electrode and the pixel electrode is indium tin oxide; the material of the wiring layer is metal.

The disclosure removes the portion of the pixel electrode adjacent to the break region, and repairs the break region through disposing two wiring layers at the two sides of the break region to respectively electrically connect with the portion of the common electrode adjacent to the break region and data lines. The area of the pixel electrode removed by the repair approach is very small. A larger area required to be removed caused by adoption of the long conductive lines in the current technology may be avoided. And because the removed area of the pixel electrode is very small, even though a micro light point appears at the removed portion, it does not have any affection visually such that the display quality of the liquid crystal panel is increased.

### BRIEF DESCRIPTION OF THE DRAWINGS

The above and other exemplary aspects, features and advantages of certain exemplary embodiments of the present disclosure will be more apparent from the following description taken in conjunction with the accompanying drawings, in which:

FIG. 1 is a schematic front view of the thin film transistor array substrate according to the embodiment of the disclosure; and

FIG. 2 is a schematic structure of t the liquid crystal display device according to the embodiment of the disclosure.

### DETAILED DESCRIPTION

The following description with reference to the accompanying drawings is provided to explain the exemplary embodiments of the disclosure. It will be apparent, however, that the disclosure may be practiced by one or more embodiments, and the specific embodiments provided herein cannot be interpreted to limit the disclosure. On the contrary, those embodiments are provided to explain the principle and the application of the disclosure such that those skilled in the art may understand the various embodiments of the disclosure and the various modifications for specific expected application.

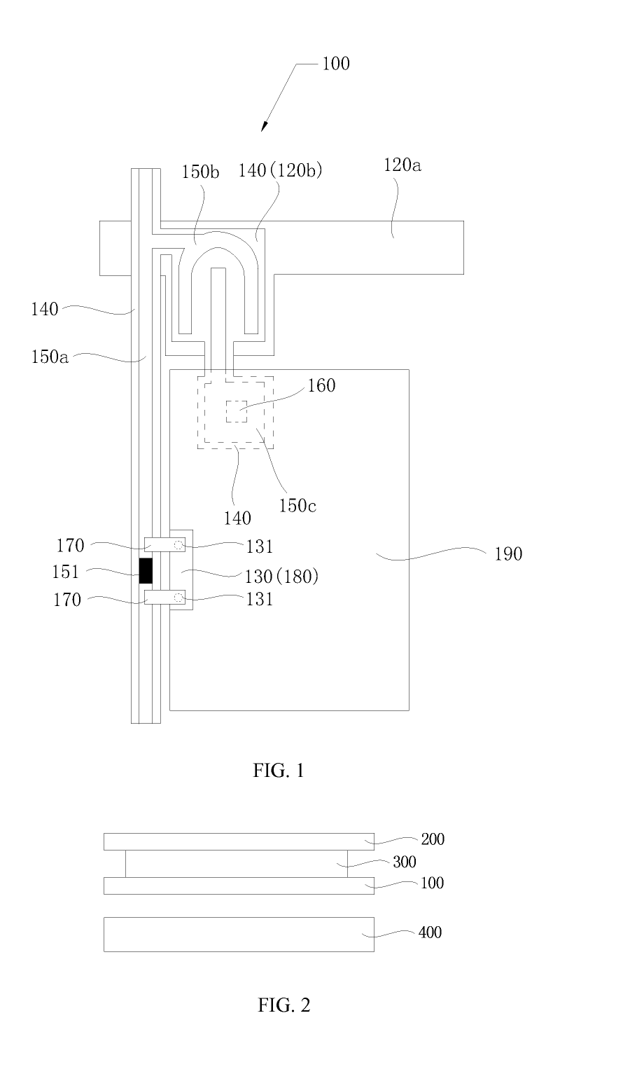

FIG. 1 is a schematic front view of the thin film transistor array substrate according to the embodiment of the disclosure. The thin film transistor array substrate generally comprises a plurality of data lines, a plurality of gate lines and a plurality of pixel regions defined by the plurality of data lines crossing with the gate lines. For clarity, FIG. 1 only shows one pixel area as an example.

Refer to FIG. 1; the thin film transistor array substrate according to the embodiment of the disclosure 100 comprises pixel regions defined by the gate lines 120a crossing with the data lines 150a. The pixel region comprises a first transparent conductive layer 180 and a second transparent conductive layer 190 disposed on the substrate (such as transparent glass substrate) 110, and a thin film transistor arranged close to the intersection of the gate line 120a and the data line 150a. The first transparent conductive layer 180 is used as a common electrode and the second transparent conductive layer 190 is used as a pixel electrode.

The thin film transistor comprises a gate terminal 120b, a first insulating layer (not shown) covering the gate terminal 120b, an a-Si layer (source layer) 140 formed by a-Si, a source terminal 150b and a drain terminal 150c on the a-Si layer, a second insulating layer (or passive layer) 130, a through hole formed above the drain terminal 150c and on the second insulating layer and a second transparent conductive layer 190, all of which formed sequentially on the substrate 110. The second transparent conductive layer 190 contacts with the drain terminal 150c by the through hole 160.

In this embodiment, the gate line 120a and the gate terminal 120b are formed by patterning the first metal layer. The data line 150a, the source terminal 150b and the drain terminal 150c are formed by the second metal layer. The first transparent conductive layer 180 and the second transparent conductive layer 190 are formed by the transparent conductive material such as indium tin oxide (ITO).

As described in the background, during the current manufacture process for the thin film transistor array substrate, there will be a large number of signal lines disconnected. Continuously refer to FIG. 1; the black region on the data line 150a is the break region 151.

In order to repair the break region 151 on the data line 150a, in this embodiment, the thin film transistor (TCT) array substrate 100 further comprises at least two wiring layers 170. A portion of the second transparent conductive layer 190 close to the break region 151 is removed such that the second insulting layer 130 under the removed portion of the second transparent conductive layer 190 is exposed, and a portion of the first transparent conductive layer 180 close to the break region 151 under the second insulating layer 140 is cut off. That is the portion of the first transparent conductive layer 180 close to the break region 151 does not have electrical contact with the remaining portion of the first transparent conductive layer 180 that is electrically insulated. Two contact holes 131 are formed on the exposed second insulating layer 130. The two wiring layers 170 are disposed on the second insulating layer 130 respectively to fill the corresponding contact hole 131 to electrically contact with the portion of the first transparent conductive layer 180 close to the break region 151. The two wiring layers are respectively disposed at the two sides of the break region 151 to electrically contact with the data line 150a to repair the break region 151.

It is appreciated from the above description that the portion of the second transparent conductive layer 190 close to the break region 151 is removed. The break region 151 is repaired through disposing two wiring layers 170 at the two sides of the break region 151 to respectively electrically connect with the portion of the first transparent conductive layer 180 adjacent to the break region 151 and data line 150a. The area of the second transparent conductive layer 190 removed by the repair approach is very small. A larger area required to be removed caused by adoption of the long conductive lines in the current technology may be avoided. And because the removed area of second transparent conductive layer 190 is very small, even though a micro light point appears at the removed portion, it demo not have any affection visually such that the display quality of the liquid crystal panel is increased.

FIG. 2 is a schematic structure of t the liquid crystal display device according to the embodiment of the disclosure.

Refer to FIG. 1, the liquid crystal display device according to the embodiment of the disclosure comprises a liquid crystal display panel and a backlight module 400 arranged oppositely to the liquid crystal display panel. The backlight module 400 provides light source to the liquid crystal display panel such that the liquid crystal display panel may display an image through the light provided by the backlight module 400. The liquid crystal display panel comprises the thin film transistor array substrate 100 as stated above and a second substrate 200, which is a color filter (CF) substrate usually comprising a black matrix and alignment layer, and a liquid crystal layer disposed between the thin film transistor array substrate 100 and the second substrate 200. The thin film transistor array substrate 100 and the second substrate 200 are arranged oppositely with each other.

As the second substrate 200 adopted in the disclosure is the same as that of the current technology, the specific structure may refer to the current technology, and the description is not repeated herein. The backlight module 400 adopted in the disclosure is the same as that the liquid crystal display device of the current technology, the specific structure may refer to the current technology, and the description is not repeated herein, either.

Although the present disclosure is illustrated and described with reference to specific embodiments, those skilled in the art will understand that many variations and modifications are readily attainable without departing from the spirit and scope of the discourse defined by the claims and the equivalent thereof.

What is claimed is:

1. A thin film transistor array substrate, comprising:
gate lines;
data lines comprising a break region;
pixel regions defined by the gate lines crossing with the scan lines, each of the pixel regions comprising a common electrode and a pixel electrode on the common electrode, the common electrode electrically insulated from the pixel electrode; and
two wiring layers respectively disposed at the two sides of the break region, the two wiring layers electrically connected with the data lines;
wherein a portion of the pixel electrode adjacent to the break region is removed; a portion of the common electrode adjacent to the break region is electrically insulated from the remaining portion; the two wiring layers are electrically connected to the portion of the common electrode adjacent to the break region.

2. The thin film transistor array substrate according to claim 1, wherein a second insulating layer is disposed in the pixel region; the second insulating layer is disposed between the pixel electrode and the common electrode.

3. The thin film transistor array substrate according to claim 2, wherein the second insulating layer on the removed portion of the pixel electrode comprises at least two contacting hole formed therein; wherein the two wiring layers are disposed on the second insulating layer, the two wiring layers are respectively filled in the corresponding contact holes to electrically connect to the portion of the common electrode adjacent to the break region.

4. The thin film transistor array substrate according to claim 3, wherein the wiring layer is electrically insulated from the pixel electrode.

5. The thin film transistor array substrate according to claim 1, wherein the material of the common electrode and the pixel electrode is indium tin oxide, the material of the wiring layer is metal.

6. The thin film transistor array substrate according to claim 2, wherein the material of the common electrode and the pixel electrode is indium tin oxide, the material of the wiring layer is metal.

7. The thin film transistor array substrate according to claim 3, wherein the material of the common electrode and the pixel electrode is indium tin oxide, the material of the wiring layer is metal.

8. The thin film transistor array substrate according to claim 4, wherein the material of the common electrode and the pixel electrode is indium tin oxide, the material of the wiring layer is metal.

9. A liquid crystal display panel, comprising:
a thin film transistor array substrate and a color filter substrate arranged oppositely to the thin film transistor array substrate;
wherein the thin film transistor array substrate comprises:
gate lines;
data lines comprising a break region;
pixel regions defined by the gate lines crossing with the scan lines, each of the pixel regions comprising a common electrode and a pixel electrode on the common electrode, the common electrode electrically insulated from the pixel electrode; and
two wiring layers respectively disposed at the two sides of the break region, the two wiring layers electrically connected with the data lines;
wherein a portion of the pixel electrode adjacent to the break region is removed; a portion of the common electrode adjacent to the break region is electrically insulated from the remaining portion; the two wiring layers are electrically connected to the portion of the common electrode adjacent to the break region.

10. The liquid crystal display panel according to claim 9, wherein a second insulating layer is disposed in the pixel region; the second insulating layer is disposed between the pixel electrode and the common electrode.

11. The liquid crystal display panel according to claim 10, wherein the second insulating layer on the removed portion of the pixel electrode comprises at least two contacting hole formed therein; wherein the two wiring layers are disposed on the second insulating layer, the two wiring layers are respectively filled in the corresponding contact holes to electrically connect to the portion of the common electrode adjacent to the break region.

12. The liquid crystal display panel according to claim 11, wherein the wiring layer is electrically insulated from the pixel electrode.

13. The liquid crystal display panel according to claim 12, wherein the material of the common electrode and the pixel electrode is indium tin oxide, the material of the wiring layer is metal.

14. The liquid crystal display panel according to claim 13, wherein the material of the common electrode and the pixel electrode is indium tin oxide, the material of the wiring layer is metal.

15. The liquid crystal display panel according to claim 14, wherein the material of the common electrode and the pixel electrode is indium tin oxide, the material of the wiring layer is metal.

16. The liquid crystal display panel according to claim 15, wherein the material of the common electrode and the pixel electrode is indium tin oxide, the material of the wiring layer is metal.
